(19) United States
(12) Patent Application Publication
(10) Pub. No.: US 2025/0356163 A1
(43) Pub. Date: Nov. 20, 2025

(54) ARTIFICIAL INTELLIGENCE DEVICE AND METHOD OF OPERATION THEREOF

(71) Applicants: LG ELECTRONICS INC., Seoul (KR); KOREA ADVANCED INSTITUTE OF SCIENCE AND TECHNOLOGY, Daejeon (KR)

(72) Inventors: Min-Wook JEONG, Seoul (KR); Yunhee KU, Seoul (KR); Sang Wan LEE, Daejeon (KR); Taekwan KIM, Daejeon (KR)

(73) Assignees: LG ELECTRONICS INC., Seoul (KR); KOREA ADVANCED INSTITUTE OF SCIENCE AND TECHNOLOGY, Daejeon (KR)

(21) Appl. No.: 19/209,303

(22) Filed: May 15, 2025

(30) Foreign Application Priority Data
May 17, 2024 (WO) PCT/KR2024/006731

(51) Int. Cl. G06N 3/042; G06N 3/048; G06N 3/092

(52) U.S. Cl. CPC G06N 3/042; G06N 3/048; G06N 3/092

(57) ABSTRACT

An artificial intelligence device according to an embodiment of the present disclosure comprises a memory configured to store a brain-mimicking artificial intelligence model learned through a reinforcement learning; a mental health measuring device configured to collect subject data including a value of a memory recall confidence, a memory recall accuracy, a value of an inference confidence, an inference accuracy, a learning accuracy, and a strategic decision-making bias according to a user's performance of a meta memory game; and a processor configured to: obtain a plurality of cognitive behavior values from the subject data using the brain mimicking artificial intelligence model, obtain a plurality of brain function estimation signals corresponding to each of the plurality of cognitive behavior values, and map each of the plurality of brain function estimation signals to a brain signal corresponding to a specific brain function.

### CROSS-REFERENCE TO RELATED APPLICATION

Pursuant to 35 U.S.C. § 119, this application claims the benefit of an earlier filing date and right of priority to International Application No. PCT/KR2024/006731, filed on May 17, 2024, the contents of which are hereby incorporated by reference herein in its entirety.

### BACKGROUND OF THE INVENTION

### 1. Field of the Invention

The present invention relates to an artificial intelligence device, and more specifically, to an artificial intelligence device capable of comprehensively measuring a user's mental health profile.

### 2. Discussion of the Related Art

Digital healthcare refers to the application of digital technology in the medical and health fields to manage patients' health, prevent disease, diagnose, and treat. Digital healthcare is achieved by utilizing various technologies such as information technology, artificial intelligence, sensor technology, and big data.

As interest in the digital healthcare industry increases, technologies that improve the accuracy of monitoring mental health are being proposed.

Related to this, prior patent 1 (Korea Patent Publication No. 10-2022-0085863) allows the presence or absence of a mental health risk to be confirmed at a superficial level from the speech sentence pattern, but there is a problem that makes it difficult to clearly observe the basis of cognitive decline (e.g., decreased memory recall) that causes the risk.

In addition, Prior Patent 2 (Korea Patent Publication No. 10-2023-0045625) has a difficult problem of the risk prediction of mental illness in which metacognition is the main impairment because it is impossible to measure metacognition (e.g., recall confidence assessment system), which is a potential mental health variable.

Prior Patent 3 (Korea Patent Publication No. 10-2020-0092457) created a cognitive explanation model by limiting human decision-making to two parts: learning and control, but the actual high-level decision-making system is comprehensively involved metacognition that reconsiders each function memory-inference in addition to learning function. Therefore, in prior patent 3, the explanatory power of the human cognitive system of the prior art is greatly reduced in situation where complexity is higher.

### SUMMARY OF THE INVENTION

The purpose of the present disclosure may be to estimate a comprehensive mental health profile of learning-memory-inference from the user's game data using a mental health measuring device using a meta memory game and a brain mimicking artificial intelligence model.

The purpose of the present disclosure may be to increase the accuracy of monitoring an individual user's mental health profile.

The purpose of the present disclosure may be to verify the reproduction of the user's brain function pattern with an optimized brain mimicking artificial intelligence model and provide individual brain function value corresponding to each cognitive behavior.

An artificial intelligence device according to an embodiment of the present disclosure comprises a memory configured to store a brain-mimicking artificial intelligence model learned through a reinforcement learning; a mental health measuring device configured to collect subject data including a value of a memory recall confidence, a memory recall accuracy, a value of an inference confidence, an inference accuracy, a learning accuracy, and a strategic decision-making bias according to a user's performance of a meta memory game; and a processor configured to: obtain a plurality of cognitive behavior values from the subject data using the brain mimicking artificial intelligence model, obtain a plurality of brain function estimation signals corresponding to each of the plurality of cognitive behavior values, and map each of the plurality of brain function estimation signals to a brain signal corresponding to a specific brain function.

According to an embodiment of the present disclosure, the following effects are achieved.

First, by providing the mental health profile of individual user as a result of data analysis of mental health measuring device through a brain mimicking artificial intelligence model, it is possible to predict mental health risks such as poor learning performance, memory recall failure, confidence bias, and decision-making strategy bias.

Second, by optimizing the parameters of the brain mimicking artificial intelligence model to maximize the ability to explain user's strategic decision-making pattern, the accuracy of monitoring individual user's mental health profile may be increased.

Third, by verifying the reproduction of the user's brain function pattern with an optimized brain mimicking artificial intelligence model, it is possible to provide individual brain function value corresponding to each cognitive behavior.

Fourth, by designing a brain mimicking artificial intelligence model based on cognitive theory, it may be applied to the digital healthcare field where damaged functions underlying cognitive impairment may be interpreted, and cognitive treatment strategy for dementia/mild cognitive impairment may be help to establish based on the interpretation provided by clinical expert.

Fifth, by mounting the mental health monitoring technology of the present invention on a care robot, it may be provided as a mental health management service platform in place where mental health personnel and accessibility are lacking, such as hospital, nursing home, and silvertown.

### BRIEF DESCRIPTION OF THE DRAWINGS

FIG. 1 is a block diagram for illustrating elements of an artificial intelligence device according to an embodiment of the present disclosure.

FIG. 2 is a diagram for illustrating the configuration of an artificial intelligence server according to an embodiment of the present disclosure.

FIG. 3 is a diagram for illustrating the configuration of an artificial intelligence system according to an embodiment of the present disclosure.

FIGS. 4A and 4B are diagrams illustrating a preliminary learning process according to an embodiment of the present disclosure, and FIC. 4C is a diagram illustrating the process of obtaining recall confidence, recall accuracy, inference confidence, and inference accuracy according to performance of meta memory game.

FIG. 5 is a diagram explaining the process of optimizing the parameters of a brain mimicking AI model according to an embodiment of the present disclosure.

FIGS. 6A and 6B are diagrams illustrating a process of optimizing parameters of a brain mimicking AI model through subject learning data of a meta memory game according to an embodiment of the present disclosure.

FIG. 7 is a diagram illustrating a process for verifying the reproducibility of brain function of a brain mimicking AI model according to an embodiment of the present disclosure.

FIG. 8A is a diagram illustrating the improved explanatory power of the brain mimicking AI model according to an embodiment of the present disclosure, and FIG. 8B is a diagram illustrating the reproducibility of the brain mimicking AI model according to an embodiment of the present disclosure.

FIG. 9 is a diagram illustrating verification of brain function reproduction and brain function estimation signal of a brain mimicking artificial intelligence model according to an embodiment of the present disclosure.

FIG. 10 is a flowchart illustrating a method of operating an artificial intelligence system according to an embodiment of the present disclosure.

FIG. 11 is a diagram illustrating the configuration of an artificial intelligence device according to another embodiment of the present disclosure.

### DETAILED DESCRIPTION OF THE PREFERRED EMBODIMENTS

Artificial intelligence refers to the field of researching artificial intelligence or methodology to create it, and machine learning refers to the field of defining various problems dealt with in the field of artificial intelligence and researching methodology to solve them.

Machine learning is also defined as an algorithm that improves the performance of a task through consistent experience.

Artificial Neural Network (ANN) is a model used in machine learning, it may refer to an overall model with problem-solving capability that is composed of artificial neurons (nodes) that form a network through the combination of synapses.

Artificial neural network may be defined by connection pattern between neurons in different layers, a learning process that updates model parameter, and an activation function that generates output value.

An artificial neural network may include an input layer, an output layer, and optionally one or more hidden layers. Each layer may include one or more neurons, and the artificial neural network may include synapse connecting neurons. In an artificial neural network, each neuron may output the input signals input through the synapse, weight, and value of activation function for bias.

Model parameter refer to a parameter determined through learning and includes the weight of synapse connection and the bias of neurons. Hyperparameter refer to a parameter that must be set before learning in a machine learning algorithm and includes learning rate, number of repetition, mini-batch size, initialization function, etc.

The purpose of learning an artificial neural network may be seen as determining model parameter that minimize the loss function. The loss function may be used as an indicator to determine optimal model parameter during the learning process of an artificial neural network.

Machine learning may be classified into supervised learning, unsupervised learning, and reinforcement learning depending on the learning method.

Supervised learning refers to a method of training an artificial neural network with a label for the learning data given, a label may mean the correct answer (or result value) that the artificial neural network must infer when learning data is input to the artificial neural network.

Unsupervised learning may refer to a method of training an artificial neural network in a state where no label for training data is given.

Reinforcement learning may refer to a learning method in which an agent defined within an environment learns to select an action or action sequence that maximizes the cumulative reward in each state.

Among artificial neural networks, machine learning implemented with a deep neural network (DNN) that includes multiple hidden layers is also called deep learning, and deep learning is a part of machine learning.

Hereinafter, machine learning is used to include deep learning.

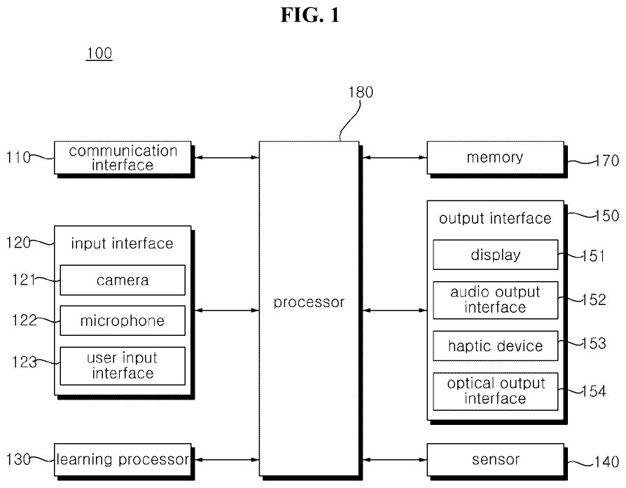

FIG. 1 is a block diagram for illustrating elements of an artificial intelligence device according to an embodiment of the present disclosure.

The artificial intelligence device 100 may be implemented as a fixed or movable device such as a TV, a projector, a mobile phone, a smartphone, a desktop computer, a laptop, a digital broadcasting terminal, a PDA (personal digital assistant), a PMP (portable multimedia player), a navigation, a tablet PC, a wearable device, and a set-top box (STB), a DMB receiver, a radio, a washing machine, a refrigerator, a desktop computer, a digital signage, a robot, a vehicle, etc.

Referring to FIG. 1, the artificial intelligence device 100 may include a communication interface 110, an input interface 120, a learning processor 130, a sensor 140, an output interface 150, a memory 170, and a processor 180.

The communication interface 110 may transmit and receive data with external device such as other artificial intelligence device or the AI server 200 using wired or wireless communication technology. For example, the communication interface 110 may transmit and receive sensor information, user input, learning model, and control signal with external device.

Communication technologies used by the communication interface 110 include Global System for Mobile communication (GSM), Code Division Multi Access (CDMA), Long Term Evolution (LTE), 5G, Wireless LAN (WLAN), and Wireless-Fidelity (Wi-Fi)., Bluetooth (Bluetooth), RFID (Radio Frequency Identification), Infrared Data Association (IrDA), ZigBee, NFC (Near Field Communication), etc.

The input interface 120 may acquire various types of data.

The input interface 120 may include a camera 121 for capturing image, a microphone 122 for receiving audio signals, and a user input interface 123 for receiving information from a user.

The camera 121 or the microphone 122 is treated as a sensor, and the signal obtained from the camera 121 or the microphone 122 may be called sensing data or sensor information.

The input interface 120 may obtain training data for model learning and input data to be used when obtaining an output using the learning model. The input interface 120 may acquire unprocessed input data, and in this case, the processor 180 or the learning processor 130 may extract input feature by preprocessing the input data.

The camera 121 processes image frame such as still image or moving image obtained by an image sensor in video call mode or photographing mode. Processed image frame may be displayed on display 151 or stored in memory 170.

The microphone 122 processes external acoustic signal into electrical voice data. The processed voice data may be utilized in various ways depending on the function (or application being executed) being performed by the artificial intelligence device 100. Meanwhile, various noise removal algorithms may be applied to the microphone 122 to remove noise generated in the process of receiving an external acoustic signal.

The user input interface 123 is for receiving information from the user, when information is input through the user input interface 123, the processor 180 may control the operation of the artificial intelligence device 100 to correspond to the input information.

The user input interface 123 is a mechanical input means (or mechanical key, for example, a button, dome switch, jog wheel, or jog switch located on the front/rear or side of the artificial intelligence device 100), etc.) and a touch input means.

As an example, the touch input may consist of a virtual key, soft key, or visual key displayed on the touch screen through software processing, or a touch key placed in a part other than the touch screen.

The learning processor 130 may train a model composed of an artificial neural network using training data. The learned artificial neural network may be referred to as a learning model. A learning model may be used to infer a result value for new input data other than learning data, and the inferred value may be used as the basis for a decision to perform an operation.

The learning processor 130 may perform AI processing together with the learning processor 240 of the AI server 200.

The learning processor 130 may include memory integrated or implemented in artificial intelligence device 100. The learning processor 130 may be implemented using the memory 170, an external memory directly coupled to the artificial intelligence device 100, or a memory maintained in an external device.

The sensor 140 may obtain at least one of internal information of the artificial intelligence device 100, information about the surrounding environment of the artificial intelligence device 100, or user information using various sensors.

The sensor 140 may include one or more of a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar sensor, or a radar sensor.

The output interface 150 may generate output related to vision, hearing, or tactile sensation.

The output interface 150 may include a display 151 that outputs an image, an audio output interface 152 that outputs audio, a haptic device 153 that outputs tactile information, and an optical output interface 154 that outputs light.

The display 151 displays (outputs) information processed by the artificial intelligence device 100. For example, the display 151 may display execution screen information of an application running on the artificial intelligence device 100, or user interface (UI) and graphic user interface (GUI) information according to the execution screen information.

The display 151 may be implemented as a touch screen by forming a mutual layer structure or being integrated with the touch sensor. The touch screen functions as a user input interface 123 that provides an input interface between the artificial intelligence device 100 and the user, and may simultaneously provide an output interface between the artificial intelligence device 100 and the user.

The audio output interface 152 may output audio data received from the communication interface 110 or stored in the memory 170 in call signal reception, call mode or recording mode, voice recognition mode, broadcast reception mode, etc.

The audio output interface 152 may include at least one of a receiver, a speaker, or a buzzer.

The haptic device 153 generates various tactile effects that the user may feel. A representative example of a tactile effect generated by the haptic device 153 may be vibration.

The light output interface 154 uses light from the light source of the artificial intelligence device 100 to output a signal to notify that an event has occurred. Examples of events that occur in the artificial intelligence device 100 may include receiving a message, receiving a call signal, a missed call, an alarm, a schedule notification, receiving an email, receiving information through an application, etc.

The memory 170 may store data supporting various functions of the artificial intelligence device 100. For example, the memory 170 may store input data obtained from the input interface 120, learning data, learning model, learning history, etc.

The processor 180 may determine at least one executable operation of the artificial intelligence device 100 based on information determined or generated using a data analysis algorithm or a machine learning algorithm.

The processor 180 may control the elements of the artificial intelligence device 100 to perform the determined operation.

To this end, the processor 180 may request, search, receive, or utilize data from the learning processor 130 or the memory 170, and may control elements of the artificial intelligence device 100 to be performed an operation that is predicted or an operation that is determined to be desirable among the at least one executable operation.

If linkage with an external device is necessary to perform a determined operation, the processor 180 may generate a control signal to control the external device and transmit the generated control signal to the external device.

The processor 180 may obtain intent information for user input and determine the user's request based on the obtained intent information.

The processor 180 may obtain intent information corresponding to the user input using at least one of a STT (Speech To Text) engine for converting voice input into a character string or a Natural Language Processing (NLP) engine for acquiring intent information of natural language.

At least one of the STT engine and the NLP engine may be composed of at least a portion of an artificial neural network learned according to a machine learning algorithm. And, at least one of the STT engine or the NLP engine may be learned by the learning processor 130, learned by the learning processor 240 of the AI server 200, or learned by distributed processing thereof.

The processor 180 collects history information including the user's feedback on the operation of the artificial intelligence device 100 and stores it in the memory 170 or the learning processor 130 or the AI server 200, etc. May be transmitted to external devices. The collected historical information may be used to update the learning model.

The processor 180 may control at least some of the elements of the artificial intelligence device 100 to run an application program stored in the memory 170.

The processor 180 may operate two or more of the elements included in the artificial intelligence device 100 in combination with each other in order to run the application program.

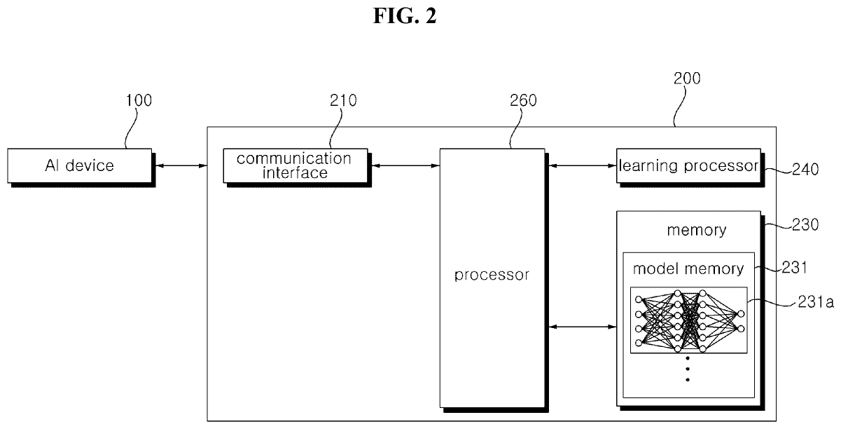

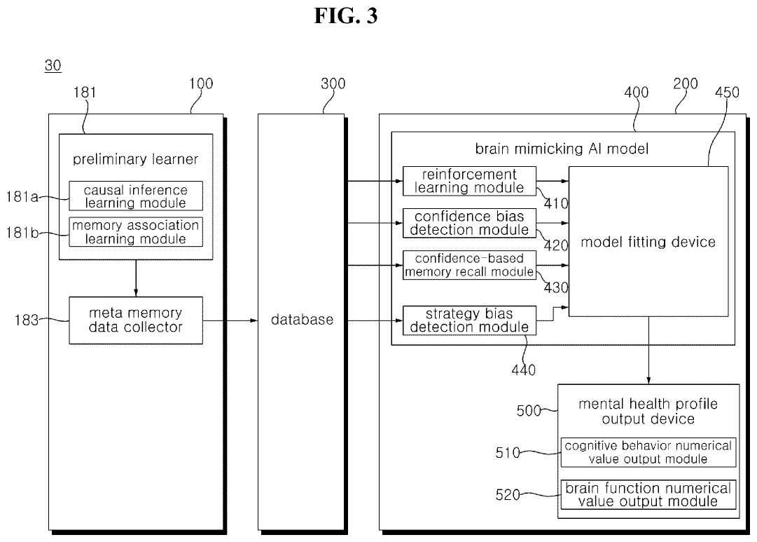

FIG. 2 is a diagram for illustrating the configuration of an artificial intelligence server according to an embodiment of the present disclosure.

Referring to FIG. 2, the AI server 200 may refer to a device that trains an artificial neural network using a machine learning algorithm or uses a learned artificial neural network.

The AI server 200 may be composed of a plurality of servers to perform distributed processing, and may be defined as a 5G network. The AI server 200 may be included as a part of the artificial intelligence device 100 and may perform at least part of the AI processing.

The AI server 200 may include a communication interface 210, a memory 230, a learning processor 240, and a processor 260.

The communication interface 210 may transmit and receive data with an external device such as the artificial intelligence device 100.

The memory 230 may include a model memory 231. The model memory 231 may store a model (or artificial neural network, 231a) that is being trained or has been learned through the learning processor 240.

The learning processor 240 may train the artificial neural network 231a using training data. The learning model may be used while mounted on the AI server 200 of the artificial neural network, or may be mounted and used on an external device such as the artificial intelligence device 100.

The learning model may be implemented in hardware, software, or a combination of hardware and software. When part or all of the learning model is implemented as software, one or more instructions constituting the learning model may be stored in the memory 230.

The processor 260 may infer a result value for new input data using a learning model and generate a response or control command based on the inferred result value.

FIG. 3 is a diagram for illustrating the configuration of an artificial intelligence system according to an embodiment of the present disclosure.

Referring to FIG. 3, the artificial intelligence system 30 according to an embodiment of the present disclosure may include an AI device 100, a database 300, and an AI server 200.

The AI device 100 may include a preliminary learner 181 and a meta memory data collector 183.

The preliminary learner 181 and the meta memory data collector 183 may be included in the processor 180 of FIG. 1 or may be elements separate from the processor 180.

The preliminary learner 181, the meta memory data collector 183, and the database 300 may be included in the device named mental health measuring device.

The preliminary learner 181 may learn prior knowledge required for causal inference and memory association. Data collected through the preliminary learner 181 may be background knowledge necessary for a user (or subject) to perform a meta memory game.

The preliminary learner 181 may include a causal inference learning module 181a and a memory association learning module 181b.

The causal inference learning module 181a allows the user to move to the next stage by selecting left or right and check the result of the selection. The causal inference learning module 181a may pre-train the state-action-result rule required for causal inference.

The memory association learning module 181b allows the user to strengthen the recall association for specific clue. For example, the memory association learning module 181b may learn the relationship between each animal (cue) and the location of food acquisition.

The meta memory data collector 183 may guide the user to make a meta memory-based power decision under three environmental conditions after prior learning through the preliminary learner 181. The three environmental conditions may include a goal specificity, a cue clarity, and an environmental uncertainty.

The meta memory data collector 183 may measure memory recall confidence as it receives user input in the first stage of the meta memory game.

The meta memory data collector 183 may measure inference confidence as it receives user input just before confirming the result in the last stage of the meta memory game.

The meta memory data collector 183 may measure an inference accuracy, a memory recall accuracy, and a learning accuracy based on the feedback presented as a result of the user's decision-making behavior.

The meta memory data collector 183 may measure strategic decision-making bias from the difference in user behavior pattern between the current trial and the previous trial.

The meta memory data collector 183 may transmit memory recall confidence, memory recall accuracy, inference confidence, inference accuracy, learning accuracy, and strategic decision-making bias to the database 300 or AI server 200.

The database 300 may receive user data collected from the meta memory data collector 183 to store it.

The database 300 may be the memory 230 of the AI server 200 or may be a separate element from the AI server 200.

The AI server 200 may include a brain mimicking AI model 400 and a mental health profile output device 500.

The brain mimicking AI model 400 may include a reinforcement learning module 410, a confidence bias detection module 420, a confidence-based memory recall module 430, a strategy bias detection module 440, and a model fitting device 450.

The reinforcement learning module 410 may calculate a learning and behavior pattern index that evaluates the subject's learning and behavior pattern using the subject's learning data and parameters through reinforcement learning.

The confidence bias detection module 420 may calculate an inference confidence pattern index that evaluates the subject's learning and behavior patterns using the subject's learning data and parameters.

The confidence-based memory recall module 430 may calculate a memory confidence pattern index using subject learning data and parameters.

The strategy bias detection module 440 may calculate a strategy modification pattern index using subject learning data and parameters.

The model fitting device 450 may optimize the parameters of each of the reinforcement learning module 410, the confidence bias detection module 420, the confidence-based memory recall module 430, and the strategy bias detection module 440.

After the parameters are optimized, the brain mimicking AI model 400 may output a plurality of cognitive behavior values from subject data received from the AI device 100.

The mental health profile output device 500 may include a cognitive behavior numerical value output module 510 and a brain function numerical output module 520.

The cognitive behavior numerical value output module 510 may transmit a plurality of cognitive behavioral numerical values output from the brain mimicking AI model 400 to the brain function numerical value output module 520.

The brain function numerical value output module 520 may modulate each cognitive behavior value through parametric modulation.

The brain function numerical value output module 520 may output a brain function estimation signal 521 by substituting the modulated cognitive behavior value into the hemodynamic function.

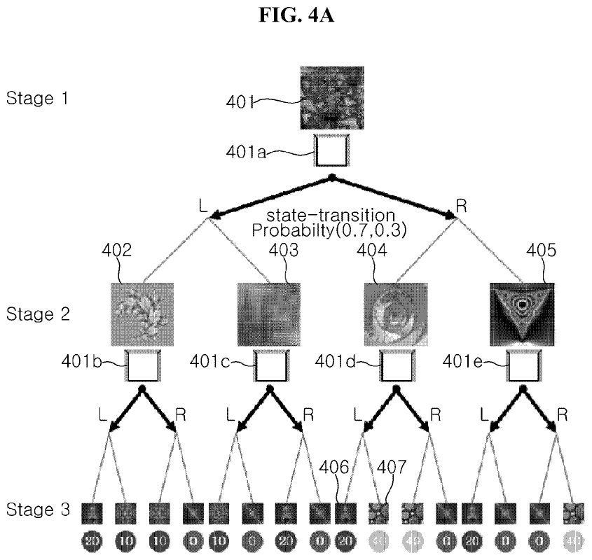

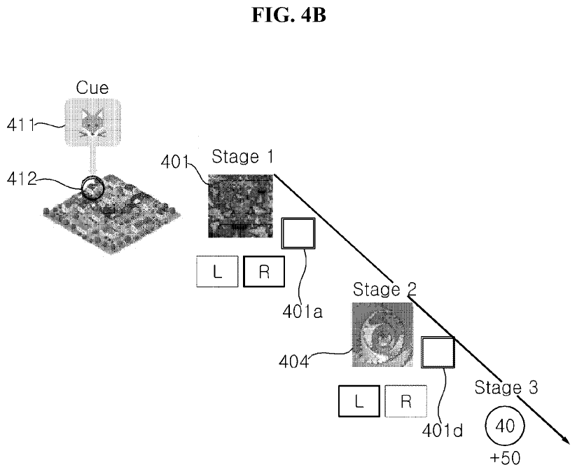

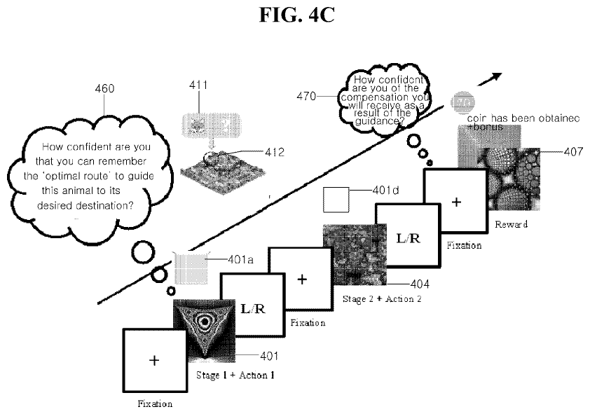

FIGS. 4A and 4B are diagrams illustrating a preliminary learning process according to an embodiment of the present disclosure, and FIC. 4C is a diagram illustrating the process of obtaining recall confidence, recall accuracy, inference confidence, and inference accuracy according to performance of meta memory game.

The meta memory game is a game that encourages users to make meta memory-based strategic decision under three environmental conditions. The three environmental conditions may be a goal specificity, a cue clarity, and an uncertainty.

Referring to FIG. 4A, the causal inference learning module 181a may display an execution screen according to execution of the causal inference learning game.

The causal inference learning module 181a may provide the following process according to the execution of the causal inference learning game.

The causal inference learning module 181a may display the first image 401 and the first box 401a on the display 151 in stage 1. The first image 401 may be a randomly displayed image among a plurality of images.

The box described below is an item related to goal specificity and may have any one of the colors blue, red, yellow, or white. Blue may be assigned 10 coins, red may be assigned 20 coins, yellow may be assigned 40 coins, and white may be assigned 0 coin.

Any one color among blue, red, yellow, and white may be randomly displayed in the first box 401a.

After a certain period of time, the causal inference learning module 181a may transit the state from stage 1 to stage 2 according to a user input of selecting the left or right mouse button.

The causal inference learning module 181a may display the second image 402 and the second box 401b or the third image 403 and the third box 401c when the user selects the left button in stage 1. To increase uncertainty, the probability that the second image 402 will be displayed may be 0.7, and the probability that the third image 403 will be displayed may be 0.3. The probability is not disclosed to the user.

The causal inference learning module 181a may display the fourth image 404 and the fourth box 401d or the fifth image 405 and the fifth box 401e when the user selects the right button in stage 1. The probability that the fourth image 404 will be displayed may be 0.7, and the probability that the fifth image 405 will be displayed may be 0.3.

The causal inference learning module 181a may transit the state from stage 2 to stage 3 when the left or right button is selected in stage 2.

For example, the causal inference learning module 181a may display the sixth image 406 or the seventh image 407 when the left button is selected in stage 2 where the fourth image 404 is being displayed. The probability that the sixth image 406 will be displayed may be 0.7, and the probability that the seventh image 407 will be displayed may be 0.3.

When the sixth image 406 is displayed in stage 3, the causal inference learning module 181a may output a notification indicating that 20 coins are given as compensation.

When the seventh image 407 is displayed in stage 3, the causal inference learning module 181a may output a notification indicating that 40 coins are given as compensation.

Users repeat the state transition process from Stage 1 to Stage 3 in order to receive as many coins as possible.

The above process may be performed multiple times for one user, and may be performed multiple times for each of multiple users.

The causal inference learning module 181a may provide coin compensation result according to stage movement and selection.

The causal inference learning module 181a allows the user to move to the next stage by selecting left or right and check the result of the selection, and may learn in advance the state-action-result rules required for causal inference.

In particular, the causal inference learning module 181a may induce user to have confidence in inference about whether they may make the optimal decision to receive a large reward.

Referring to FIG. 4B, the AI device 100 may display an execution screen according to execution of the memory association learning game.

The memory association learning module 181b may provide the following process according to the execution of the memory association learning game. In the memory association learning game, unlike the causal inference learning game, one or more of the first clue (or cue, 411) or the second clue 412 may be additionally displayed in Stage 1.

The first clue 411 may be an animal image representing an animal, and the second clue 412 may be a place image representing a place where the animal obtains food.

The memory association learning module 181b displays either the first image 401, the first box 401a, and the first clue 411 or the second clue 412 on the display 151 in stage 1.

The memory association learning module 181b may transit the state from stage 1 to stage 2 according to selection of the right button and display the fourth image 404 and the fourth box 401d.

When the left button is selected, the memory association learning module 181b may transit the state from stage 2 to stage 3 and display the final image. The memory association learning module 181b may output a coin acquisition notification indicating that 40 coins and a bonus coin (50 coins) have been granted when the color of the displayed image matches the color of the first box 401a and the displayed image matches the first clue 411 or the second clue 412.

Users may recognize how much coins they will be rewarded by following this path.

The memory association learning module 181b allows the user to remember the path indicating the animal's food acquisition location, allowing the user to strengthen a specific cue-recall association.

In particular, the memory association learning module 181b may induce the user to have confidence in memory recall regarding which choice to make when given a clue to receive the maximum coin reward.

FIG. 4C is a diagram illustrating the process by which the meta memory data collector 183 acquires memory recall confidence, memory recall accuracy, inference confidence, and inference accuracy according to the execution of the meta memory game.

The meta memory data collector 183 may display a first input window 460 for inputting memory recall confidence before entering stage 1 of the meta memory game, a first clue 411 representing the animal, and a second cue 411 representing the animal's food acquisition location.

The first input window 460 may be a window for inputting memory recall confidence indicating how well one may find the path to the goal (place of obtaining food). The meta memory data collector 183 may obtain a value of memory recall confidence through the first input window 460. The value of memory recall confidence may be anywhere from 0 to 10, but this is only an example.

Afterwards, the meta memory data collector 183 may display a first image 401 randomly selected from among the plurality of images and a first box 401a with a random color.

Afterwards, the meta memory data collector 183 may transit the state from stage 1 to stage 2 when either the left or right button is selected according to the user action.

Afterwards, the meta memory data collector 183 may display the fourth image 404 and the fourth box 401d.

When either the left button or the right button is selected according to the user action, the meta memory data collector 183 may display an input window 470 for input of inference confidence before confirming the result of stage 3 of the meta memory game.

The second input window 470 may be a window for inputting inference confidence indicating how well the reward will be received in this round. For example, inference confidence may be confidence in predicting whether or not food will be obtained.

The meta memory data collector 183 may obtain the value of inference confidence through the second input window 470. The number of inference confidence may be anywhere from 0 to 10, but this number is only an example. The second input window 470 may further include a compensation prediction input item for inputting the expected amount of compensation.

The meta memory data collector 183 may obtain memory recall accuracy, learning accuracy and inference accuracy based on the first clue 411 and the second clue 412 presented when executing the metagame and the subject's selection collected when transitioning from stage 1 to stage 2.

The meta memory data collector 183 may measure learning accuracy based on feedback presented as a result of the user's decision-making behavior.

The meta memory data collector 183 may measure strategic decision-making bias based on the difference in the user's behavior pattern between the current trial and the previous trial.

The meta memory data collector 183 may acquire subject learning data including the value of memory recall confidence, memory recall accuracy, value of inference confidence, inference accuracy, learning accuracy, and strategic decision-making bias.

After optimizing the parameters of the brain mimicking AI model, the meta memory data collector 183 may obtain subject data including the value of memory recall confidence, memory recall accuracy, value of inference confidence, inference accuracy, learning accuracy, and strategic decision-making bias.

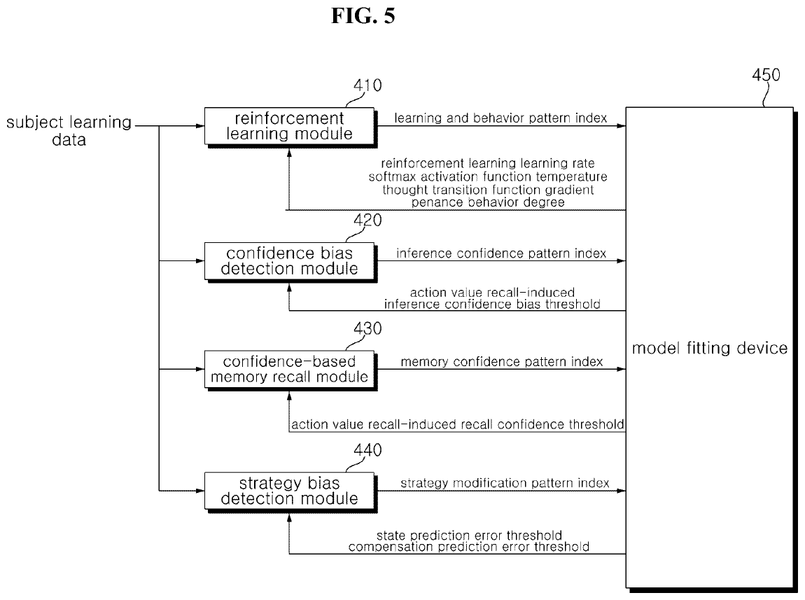

FIG. 5 is a diagram explaining the process of optimizing the parameters of a brain mimicking AI model according to an embodiment of the present disclosure.

The brain mimicking AI model 400 may include a reinforcement learning module 410, a confidence bias detection module 420, a confidence-based memory recall module 430, a strategy bias detection module 440, and a model fitting device 450.

The brain mimicking AI model 400 may be included in any one of the processor 260, the learning processor 240, or the model memory 231a of the AI server 200.

The brain mimicking AI model 400 may determine model parameters using maximum likelihood estimation (MLE). The maximum likelihood method may be a technique for selecting parameter that maximizes the likelihood that given data will occur.

Since subject learning data of the brain mimicking AI model 400 may be different for each user, the values of model parameters may also be optimized differently.

Each of the reinforcement learning module 410, the confidence bias detection module 420, the confidence-based memory recall module 430, and the strategy bias detection module 440 may use reinforcement learning and use the maximum likelihood method for parameter optimization.

The reinforcement learning module 410 may calculate a learning and behavior pattern index that evaluates the subject's learning and behavior pattern using the subject's learning data and parameters through reinforcement learning.

Parameters of the reinforcement learning module 410 may include a reinforcement learning learning rate, a softmax activation function temperature, a thought transition function gradient, and penance behavior degree.

The learning and behavior pattern index may be an index indicating how well the reinforcement learning module 410 explains actual subject data. The learning and behavior pattern index may include learned behavior value, recalled behavior value, and learning-memory integrated behavior value.

The smaller a value of the learning and behavior pattern index, the better the reinforcement learning module 410 explains the subject's data.

The learning and behavior pattern index may be output to the model fitting device 450. The model fitting device 450 may change the values of parameters in a direction that minimizes the values of the learning and behavior pattern index, and transmit the changed values of the parameters to the reinforcement learning module 410.

The model fitting device 450 may instruct the reinforcement learning model 410 to calculate the learning and behavior pattern index using the changed values of parameters. When the value of the new learning and behavior pattern index converges to the minimum value, the model fitting device 450 may transmit the output of the values of the parameters corresponding to the minimum value to the mental health profile output device 500.

If the value of the new learning and behavior pattern index does not converge to the minimum value, the model fitting device 450 may change the values of the parameters until the value of the new learning and behavior pattern index converges to the minimum value.

The confidence bias detection module 420 may calculate an inference confidence pattern index that evaluates the subject's learning and behavior patterns using the subject's learning data and parameters. The inference confidence pattern index may include an inference confidence bias.

A parameter for learning of the confidence bias detection module 420 may include an action value recall-induced inference confidence bias threshold.

The inference confidence pattern index may be an index indicating how well the confidence bias detection module 420 explains the subject's data.

The smaller the value of the inference confidence pattern index, the better the confidence bias detection module 420 explains the subject's data.

The inference confidence pattern index may be output to the model fitting device 450. The model fitting device 450 may change the value of the parameter in a direction that minimizes the value of the inference confidence pattern index, and may transmit the changed value of parameter to the confidence bias detection module 420.

The model fitting device 450 may instruct the confidence bias detection module 420 to calculate an inference confidence pattern index using the changed value of parameter. When the value of the new inference confidence pattern index converges to the minimum value, the model fitting device 450 may transmit the output of the value of parameter corresponding to the minimum value to the mental health profile output device 500.

If the value of the new inference confidence pattern index does not converge to the minimum value, the model fitting device 450 may change the value of the parameter until the value of the new inference confidence pattern index converges to the minimum value.

The confidence-based memory recall module 430 may calculate a memory confidence pattern index using subject learning data and parameters. The memory confidence pattern index may include recall confidence bias.

A parameter for learning of the confidence-based memory recall module 430 may include an action value recall-induced recall confidence threshold.

The memory confidence pattern index may be an index indicating how well the confidence-based memory recall module 430 explains the subject's data.

The smaller the value of the memory confidence pattern index, the better the confidence-based memory recall module 430 explains the subject's data.

The memory confidence pattern index may be output to the model fitting device 450. The model fitting device 450 may change the value of the parameter in a direction that minimizes the value of the memory confidence pattern index, and may transmit the changed value of the parameter to the confidence-based memory recall module 430.

The model fitting device 450 may instruct the confidence-based memory recall module 430 to calculate a memory confidence pattern index using the changed value of the parameter. When the value of the new memory confidence pattern index converges to the minimum value, the model fitting device 450 may transmit the output of the parameter value corresponding to the minimum value to the mental health profile output device 500.

If the value of the new memory confidence pattern index does not converge to the minimum value, the model fitting device 450 may change the value of the parameter until the value of the new memory confidence pattern index converges to the minimum value.

The strategy bias detection module 440 may calculate a strategy modification pattern index using subject learning data and parameters. The strategy modification pattern index may include a reward prediction error, a state prediction error, a prediction reliability, and a behavioral strategy modification power.

Parameters for learning of the strategy bias detection module 440 may include a state prediction error threshold and a compensation prediction error threshold.

The strategy modification pattern index may be an index indicating how well the strategy bias detection module 440 explains the subject data.

The smaller the value of the strategy modification pattern index, the better the strategy bias detection module 440 explains the subject data.

The strategy modification pattern index may be output to the model fitting device 450. The model fitting device 450 may change the parameter value in a direction that minimizes the value of the strategy modification pattern index, and may transmit the changed parameter value to the strategy bias detection module 440.

The model fitting device 450 may instruct the strategy bias detection module 440 to calculate a strategy modification pattern index using the changed parameter value. When the value of the new strategy modification pattern index converges to the minimum value, the model fitting device 450 may transmit the output of the parameter value corresponding to the minimum value to the mental health profile output device 500.

If the value of the new strategy modification pattern index does not converge to the minimum value, the model fitting device 450 may change the value of the parameter until the value of the new strategy modification pattern index converges to the minimum value.

In this way, the model fitting device 450 may optimize the parameter values of each module included in the brain mimicking AI model 400.

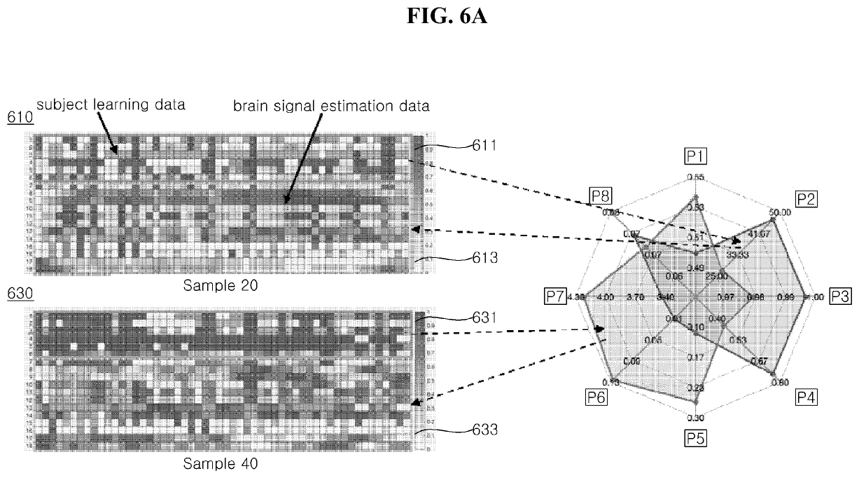

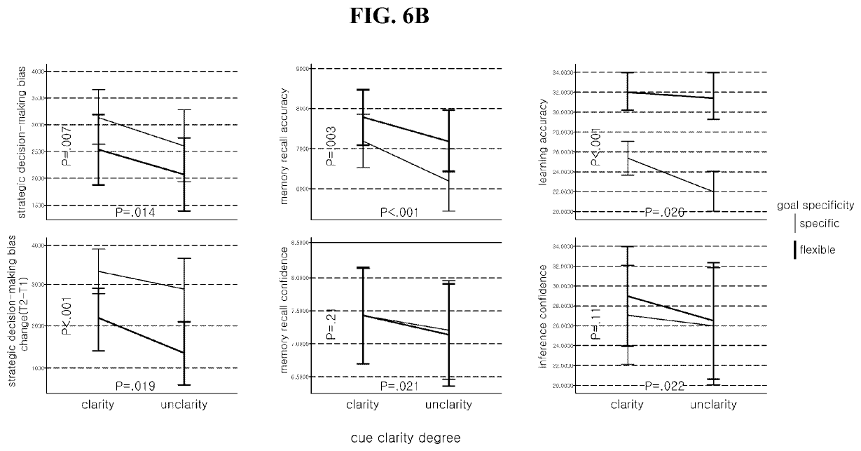

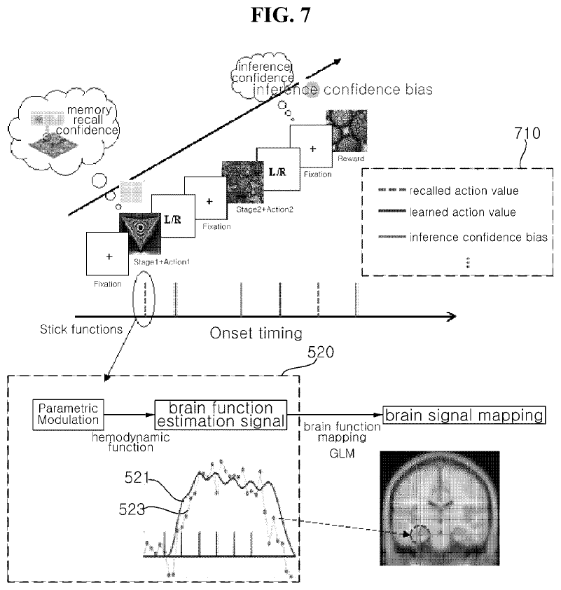

FIGS. 6A and 6B are diagrams illustrating a process of optimizing parameters of a brain mimicking AI model through subject learning data of a meta memory game according to an embodiment of the present disclosure.

Referring to FIG. 6A, the first sampling result 610 obtained according to the implementation of the metagame of user number 20 and the second sampling result 630 obtained according to the implementation of the metagame of user number 40 are shown.

The first sampling result 610 may include a first subject learning data set 611 and a first brain signal estimation data set 613.

The first subject learning data set 611 may be a set of subject learning data obtained from each of user number 20 trials. The first brain signal estimation data set 613 may be data on brain signals estimated from each of user number 20 trials.

Data on brain signal may include the values of indexes output by each module in FIG. 5.

The second sampling result 630 may include a second subject learning data set 631 and a second brain signal estimation data set 633.

The P1 model parameter is the state prediction error threshold, the P2 model parameter is the reward prediction error threshold, the P3 model parameter is the action value recall-induced inference confidence bias threshold, the P4 model parameter is the action value recall-induced recall confidence threshold, and P5 model parameter is the softmax activation function temperature, the P6 model parameter is the reinforcement learning rate, the P7 model parameter is the thought transition function gradient, and the P8 model parameter is the degree of pacing behavior.

Referring to FIG. 6A, the values of parameters of the brain mimicking AI model corresponding to user number 20 and the values of parameters of the brain mimicking AI model corresponding to user number 40 may be different from each other. That is, the values of model parameters optimized may vary depending on the user.

Referring to FIG. 6B, subject learning data measured with the meta memory game is shown. Subject learning data may include memory recall confidence, memory recall accuracy, inference confidence, inference ability, learning accuracy, and strategic decision-making bias.

FIG. 6B shows that a change of mental health may be sensitively measured depending on environmental conditions of cue clarity and goal specificity.

Clue clarity may be classified as clear or unclear. Goal specificity may be classified as a specific goal or a flexible goal.

The model fitting device 450 may search for an optimal combination of a plurality of model parameters through the process of FIG. 5.

The brain mimicking AI model 400, with optimized model parameters, may output a cognitive behavior value set including a reward prediction error, a state prediction error, a prediction reliability, a learned action value, a recalled action value, and a learning-memory integrated action value, an inference confidence bias, a recall confidence bias, and a behavioral strategy modification ability through the cognitive behavior value output module 510.

FIG. 7 is a diagram illustrating a process for verifying the reproducibility of brain function of a brain mimicking AI model according to an embodiment of the present disclosure.

Referring to FIG. 7, the brain mimicking AI model 400 may transmit the cognitive behavior value set 710 including cognitive behavior values to the cognitive behavior value output module 510. The cognitive behavior value output module 510 may output the cognitive behavior value set 710 to the brain function numerical value output module 520.

The brain function numerical value output module 520 may modulate each cognitive behavior value through parametric modulation.

The brain function numerical value output module 520 may output a brain function estimation signal 521 by substituting the modulated cognitive behavior value into the hemodynamic function.

The brain function estimation signal 521 may be input into a brain function mapping GLM (General Linear Model) regression function and be mapped with the brain signal 523 measured through actual brain electrode.

The processor 260 of the AI server 200 may input the brain function estimation signal 521 into the brain function mapping GLM regression function and map it to the previously measured brain function signal 523.

The memory 230 may store data on a plurality of previously measured brain function signals.

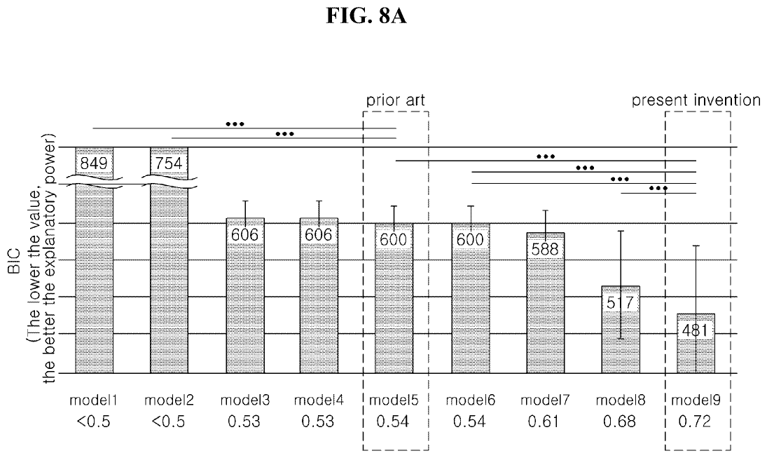

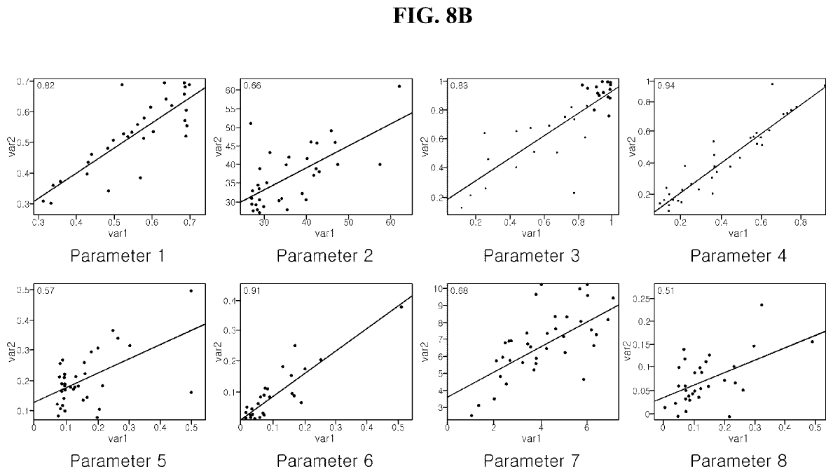

FIG. 8A is a diagram illustrating the improved explanatory power of the brain mimicking AI model according to an embodiment of the present disclosure, and FIG. 8B is a diagram illustrating the reproducibility of the brain mimicking AI model according to an embodiment of the present disclosure.

Referring to FIG. 8A, the brain model AI model (Model 9) according to an embodiment of the present disclosure is a structure that recalls strategic action values by considering inference/recall confidence and uses this to coordinate learning strategy (see FIG. 5), and it explains human strategic decision-making at a meaningful level compared to models other candidates (Using the ‘negative logarithm value of explainability’ as an input value for the Bayesian Inference Criterion [BIC], which is a model comparison value, the lower the value, the better the explanatory power).

In particular, the prediction accuracy of the brain mimicking artificial intelligence model of this disclosure is 72%, which is an 18% improvement in prediction accuracy compared to the prior art model (Prior Patent 3, Korea Patent Publication No. 10-2020-0092457).

FIG. 8B is an example of reproducibility verification to diagnose overfitting problem in a brain mimicking artificial intelligence model.

As a result of retraining the model with behavioral data reproduced with a brain-mimicking artificial intelligence model, a significant correlation was confirmed between the initial parameters and the reproduction parameters for all eight model parameters (parameters 1 to 8) (p<0.001).

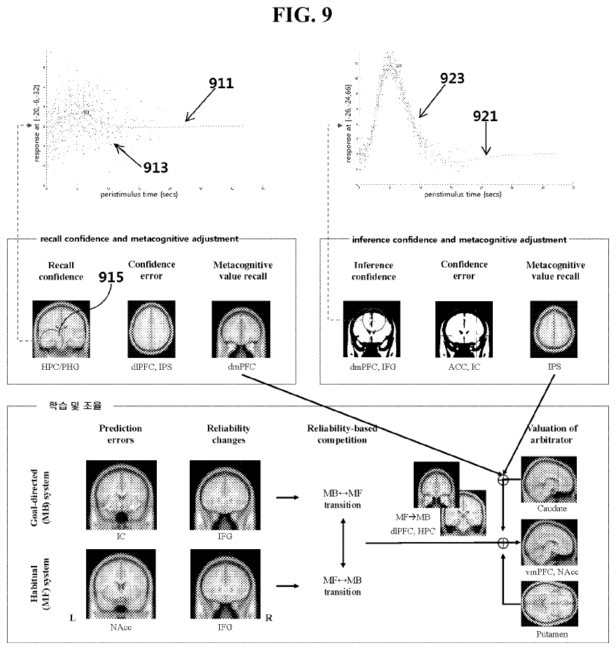

FIG. 9 is a diagram illustrating verification of brain function reproduction and brain function estimation signal of a brain mimicking artificial intelligence model according to an embodiment of the present disclosure.

The functional MRI (Magnetic Resonance Imaging) brain function activity (brain function data) measured while the user is playing the meta memory game and the brain function estimation signal output by the brain function numerical value output module 520 may be mapped for each cognitive-behavioral variable with nodes of the frontal lobe-basal ganglia-hippocampus network of the brain.

Each cognitive behavior value may be mapped to a brain signal with predictive activity for a specific brain function.

The brain function numerical value output module 520 may output a brain function estimation signal representing the mapped brain function for each cognitive behavior variable (example: memory recall confidence, inference confidence).

The first brain function estimation data 911 about the hippocampus or the hippocampus area 915 of the brain related to memory recall confidence may be mapped to the measured first brain function data 913.

The second brain function estimation data 921 for the ventromedial prefrontal cortex or inferior frontal gyrus 925 of the brain, which is associated with inference confidence, may be mapped to measured second brain function data 923.

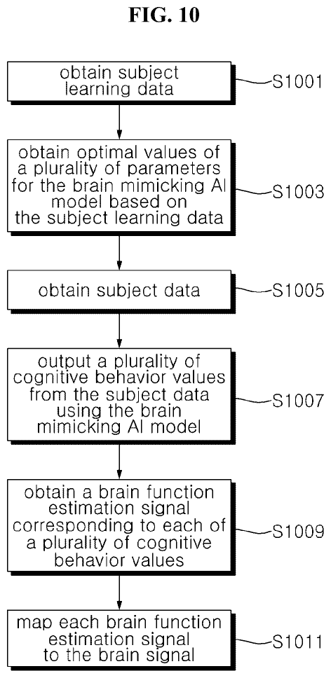

FIG. 10 is a flowchart illustrating a method of operating an artificial intelligence system according to an embodiment of the present disclosure.

The processor 260 of the AI server 200 may obtain subject learning data (S1001).

The processor 260 may receive the subject learning data from the meta memory data collector 183 of the AI device 100. The subject learning data may include data obtained through repeated performance of the preliminary learner 181 and data obtained through repeated performance of the meta memory game.

The subject learning data may include the memory recall confidence, the memory recall accuracy, the inference confidence, the inference accuracy, the learning accuracy, and the strategic decision-making bias.

The processor 260 of the AI server 200 may obtain optimal values of a plurality of parameters for the brain mimicking AI model 400 based on the subject learning data (S1003).

The brain mimicking AI model 400 may be an artificial neural network-based model learned through deep learning or machine learning. The brain mimicking AI model 400 may be a model that outputs a plurality of cognitive behavior values from subject data through an artificial neural network.

The plurality of cognitive behavior values may include the reward prediction error, the state prediction error, the prediction reliability, the learned behavioral value, the recalled behavioral value, the learning-memory integrated behavioral value, the inference confidence bias, the recall confidence bias, and the behavioral strategy modification power.

Each of the plurality of model parameters constituting the brain mimicking AI model 400 may have a value optimized by the embodiment of FIG. 3.

The processor 260 of the AI server 200 may obtain subject data (S1005) and output a plurality of cognitive behavior values from the subject data using the brain mimicking AI model 400 (S1007).

The processor 260 may receive subject data according to the performance of the meta memory game from the meta memory data collector 183 of the AI device 100. The subject data may include data obtained through repeated performance of the meta memory game.

The processor 260 may obtain a plurality of cognitive behavior values by inputting the subject data into the brain mimicking AI model 400 in which parameter values are optimized.

Each of the plurality of cognitive behavioral measures may be estimated data describing a specific brain function.

The processor 260 of the AI server 200 may obtain a brain function estimation signal corresponding to each of a plurality of cognitive behavior values (S1009).

The processor 260 may obtain a brain function estimation signal from each cognitive behavior value through the brain function numerical value output module 520.

The processor 260 of the AI server 200 may map each brain function estimation signal to the measured brain signal (S1011).

The memory 230 may store brain signals measured in each of a plurality of brain functions (or brain regions). The stored brain signal may be a signal measured through functional magnetic resonance imaging (FMRI) technology. The functional magnetic resonance imaging (FMRI) is a non-invasive neuroimaging technique for measuring brain activity, it may be a technique that measures brain blood flow and metabolic activity to output signal showing how specific area of the brain react when performing specific task.

The processor 260 may map the acquired brain function estimation signal to one of the brain signals stored in the memory 230.

As the brain function estimation signal is mapped to the measured brain signal, it may be determined whether the subject's specific brain function is operating normally.

In addition, by providing individual user's mental health profile based on the analysis of brain function estimation signal, which is the output of the brain mimicking AI model, it is possible to predict mental health risks such as poor learning performance, memory recall failure, confidence bias, and decision-making strategy bias.

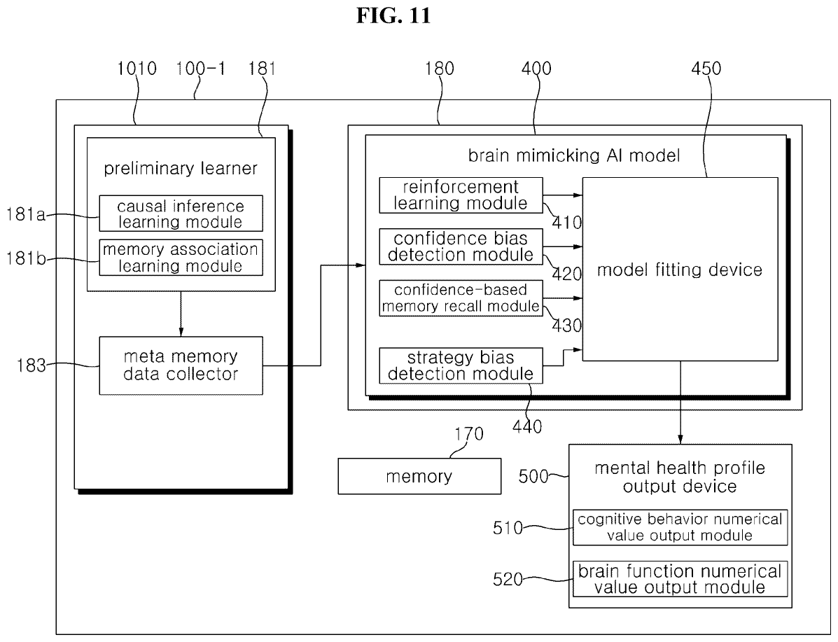

FIG. 11 is a diagram illustrating the configuration of an artificial intelligence device according to another embodiment of the present disclosure.

Each step described in the embodiment of FIG. 10 may be performed by the AI device 100-1 of FIG. 10.

The AI device 100-1 may include a mental health measuring device 1010, a memory 170, a mental health profile output device 500, and a processor 180.

The mental health measuring device 1010 may include a preliminary learner 181 and a meta memory data collector 183.

The functions of the preliminary learner 181 and the meta memory data collector 183 are replaced with the embodiments of FIGS. 3 and 4A to 4C.

The mental health measuring device 1010 may transmit subject learning data including measured memory recall confidence, memory recall accuracy, inference confidence, inference accuracy, learning accuracy, and strategic decision-making bias to the brain mimicking AI model 400.

The processor 180 may include a brain mimicking AI model 400.

The brain mimicking AI model 400 may include a reinforcement learning module 410, a confidence bias detection module 420, a confidence-based memory recall module 430, a strategy bias detection module 440, and a model fitting device 450.

The brain mimicking AI model 400 may optimize the values of a plurality of parameters from the subject learning data. The process of optimizing the values of a plurality of parameters is replaced with the embodiment of FIG. 5.

A mental health profile output device 500 may include a cognitive behavior numerical value output module 510 and a brain function numerical output module 520.

The cognitive behavior value output module 510 may transmit a plurality of cognitive behavioral numerical values output from the brain mimicking AI model 400 to the brain function numerical value output module 520.

The brain function numerical value output module 520 may modulate each cognitive behavior value through parametric modulation.

The brain function numerical value output module 520 may output a brain function estimation signal 521 by substituting the modulated cognitive behavior value into the hemodynamic function.

The cognitive behavior value output module 510 may be included in the processor 180.

The processor 180 may control the overall operation of the AI device 100-1.

The processor 180 of the AI device 100-1 may acquire subject data and output a plurality of cognitive behavior values from the subject data using the brain mimicking AI model 400.

The processor 180 of the AI device 100-1 may receive the subject data according to the performance of the meta memory game from the meta memory data collector 183. The subject data may include data obtained through repeated performance of a meta memory game.

The processor 180 of the AI device 100-1 may obtain a plurality of cognitive behavior values by inputting subject data into the brain mimicking AI model 400 with optimized parameter values.

Each of the plurality of cognitive behavioral values may be estimated data describing a specific brain function.

The processor 180 of the AI device 100-1 may obtain a brain function estimation signal corresponding to each of a plurality of cognitive behavior values.

The processor 180 of the AI device 100-1 may obtain a brain function estimation signal from each cognitive behavior value through the brain function numerical value output module 520.

The processor 180 of the AI device 100-1 may map each brain function estimation signal to the measured brain signal.

The memory 170 may store brain signals measured in each of a plurality of brain functions (or brain regions). The stored brain signals may be signals measured through functional magnetic resonance imaging (FMRI) technology.

The processor 180 of the AI device 100-1 may map the acquired brain function estimation signal to one of the brain signals stored in the memory 170.

As the brain function estimation signal is mapped to the measured brain signal, it may be determined whether the subject's specific brain function is operating normally.

The present disclosure described above may be implemented as computer-readable code on a program-recorded medium. Computer-readable media includes all types of recording devices that store data that may be read by a computer system. Examples of computer-readable media include HDD (Hard Disk Drive), SSD (Solid State Disk), SDD (Silicon Disk Drive), ROM, RAM, CD-ROM, magnetic tape, floppy disk, optical data storage device, etc. Additionally, the computer may include a processor 180 of an artificial intelligence device.

What is claimed is:

1. An artificial intelligence device comprising:
a memory configured to store an artificial intelligence (AI) model trained through reinforcement learning; and
a processor configured to:
obtain a plurality of cognitive behavior values via the artificial intelligence model based on subject data, wherein the subject data is collected according to performance of the subject in a meta memory game and comprises one or more values related to memory recall confidence, memory recall accuracy, inference confidence, inference accuracy, learning accuracy, and strategic decision making bias;
obtain a plurality of brain function estimation signals corresponding to each of the plurality of cognitive behavior values; and
map each of the plurality of brain function estimation signals to a brain signal corresponding to a specific brain function.

2. The artificial intelligence device of claim 1, wherein the processor is further configured to optimize model parameters of the AI model using Maximum Likelihood Estimation (MLE), and
wherein the model parameters include a reinforcement learning rate, a softmax activation function temperature, a gradient of thought transition function and a degree of a penance behavior, an action value recall-induced inference confidence bias threshold, an action value recall-induced recall confidence threshold, a state prediction error threshold, and a reward prediction error threshold.

3. The artificial intelligence device of claim 2, wherein the AI model comprises:
a reinforcement learning module configured with the reinforcement learning rate, the softmax activation function temperature, the gradient of the thought transition function, and the degree of the penance behavior as model parameters, wherein the reinforcement learning module is configured to output a learning and behavior pattern index from the subject data;
a confidence bias detection module configured with the action value recall-induced inference confidence bias threshold as a model parameter, and is further configured to output an inference confidence pattern index from the subject data;
a confidence-based memory recall module configured with the behavioral value recall-induced recall confidence threshold as a model parameter, and is further configured to output a memory confidence pattern index from the subject data;
a strategy bias detection module configured with the state prediction error threshold and a compensation prediction error threshold as model parameters, and is further configured to output a strategy modification pattern index; and
a model fitting device configured to optimize each of the model parameters.

4. The artificial intelligence device of claim 3, wherein the model fitting device is configured to:
change a value of each model parameter in a direction that minimizes the value of each of the learning and behavior pattern index, the inference confidence pattern index, the memory confidence pattern index, and the strategy modification pattern index.

5. The artificial intelligence device of claim 4, wherein the processor is further configured to:
modulate each of the plurality of cognitive behavior values through a parametric modulation,
obtain the plurality of brain function estimation signals using the modulated plurality of cognitive behavior values using a hemodynamic function, and
map the plurality of brain function estimation signals to the brain signals with predicted activity.

6. The artificial intelligence device of claim 1, wherein the subject data is collected by a mental health measuring device comprising:
a preliminary learner configured to learn prior knowledge required for a causal inference and a memory association; and
a meta memory data collector configured to collect the subject data according to performance of the subject in the meta memory game after learning the prior knowledge through the preliminary learner.

7. The artificial intelligence device of claim 2, wherein the processor is further configured to optimize the model parameters differently for each subject.

8. A method of operating an artificial intelligence device, the method comprising:
collecting subject data according to a subject's performance in a meta memory game, the subject data comprising one or more values related to memory recall confidence, memory recall accuracy, inference confidence, inference accuracy, learning accuracy, and strategic decision-making bias;
obtaining a plurality of cognitive behavior values via a trained artificial intelligence (AI) model based on the subject data;
obtaining a plurality of brain function estimation signals corresponding to each of the plurality of cognitive behavior values; and
mapping each of the plurality of brain function estimation signals to a brain signal corresponding to a specific brain function.

9. The method of claim 8, further comprising:
optimizing model parameters of the AI model using Maximum Likelihood Estimation (MLE),
wherein the model parameters include a reinforcement learning rate, a softmax activation function temperature, a gradient of thought transition function and a degree of a penance behavior, an action value recall-induced inference confidence bias threshold, an action value recall-induced recall confidence threshold, a state prediction error threshold, and a reward prediction error threshold.

10. The method of claim 9, wherein the AI model comprises:
a reinforcement learning module configured with the reinforcement learning rate, the softmax activation function temperature, the gradient of the thought transition function, and the degree of the penance behavior as model parameters, wherein the reinforcement learning module is configured to output a learning and behavior pattern index from the subject data;
a confidence bias detection module configured with the action value recall-induced inference confidence bias threshold as a model parameter, and is further configured to output an inference confidence pattern index from the subject data;
a confidence-based memory recall module configured with the behavioral value recall-induced recall confidence threshold as a model parameter, and is further configured to output a memory confidence pattern index from the subject data;
a strategy bias detection module configured with the state prediction error threshold and a compensation prediction error threshold as model parameters, and is further configured to output a strategy modification pattern index; and
a model fitting device configured to optimize each of the model parameters.

11. The method of claim 10, wherein optimizing the model parameters comprises:
changing, by the model fitting device, a value of each model parameter in a direction that minimizes the value of each of the learning and behavior pattern index, the inference confidence pattern index, the memory confidence pattern index, and the strategy modification pattern index.

12. The method of claim 11, wherein the obtaining the plurality of brain function estimation signals comprises:
modulating each of the plurality of cognitive behavior values through a parametric modulation,
generating a brain function estimation signal using the modulated cognitive behavior value using a hemodynamic function, and
mapping the generated brain function estimation signal to the brain signal with predicted activity.

13. The method of claim 8, wherein the collecting the subject data comprises:
learning prior knowledge required for a causal inference and a memory association, and
collecting the subject data according to the subject's performance in the meta memory game after learning the prior knowledge.

14. The method of claim 9, wherein the model parameters are optimized differently for each subject.
